(19) United States
(12) Patent Application Publication
(10) Pub. No.: US 2025/0381692 A1
(43) Pub. Date: Dec. 18, 2025

(54) SHAVING RAZOR CARTRIDGE

(71) Applicant: The Gillette Company LLC, Boston, MA (US)

(72) Inventors: Jack Anthony Washington, Wrentham, MA (US); Hannah Mary Eleanor Bayard, Boston, MA (US); Caitlin Renee Crowley, Quincy, MA (US); Larkin Mae Gillespie, Boston, MA (US); Aiqin Li, Foxboro, MA (US)

(21) Appl. No.: 18/746,239

(22) Filed: Jun. 18, 2024

(51) Int. Cl. B26B 21/40

(52) U.S. Cl. CPC B26B 21/4031; B26B 21/4018; B26B 21/4025

(57) ABSTRACT

A shaving razor cartridge with a housing, a guard at a front of the housing and a cap at a rear of the housing. A first blade mounted to the housing having a cutting edge nearest the guard. A second blade mounted to the housing having a cutting edge. A third blade mounted to the housing having a cutting edge. A blade plane defined by the cutting edges of the first, second and third blades. A first blade angle defined by the blade plane and a plane extending from the cutting edge of the first blade to a top surface of the guard. A second blade angle defined by the blade plane and a plane extending from the cutting edge of the third blade to the top surface of the guard. A ratio of the first blade angle to the second blade angle is 4:5 to 4:1.

### FIELD OF THE INVENTION

The present invention relates to razor cartridges, specifically the arrangement of blades within a razor cartridge.

### BACKGROUND OF THE INVENTION

In general, shaving razors of the wet shave type include a cartridge or blade unit with at least one blade with a cutting edge, which is moved across the surface of the skin being shaved by means of a handle to which the cartridge is attached. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled (i.e., disposable razor). The cartridge may pivot with respect to the handle so that the cartridge angle adjusts to follow the contours of the surface being shaved. In such systems, the cartridge can be biased toward a rest position by the action of a biasing member on the handle or the cartridge housing.

Razor cartridges usually include a guard which contacts the skin in front of the blade(s) and a cap for contacting the skin behind the blade(s) during shaving. The cap may comprise a water leachable shaving aid to reduce drag and improve comfort. The guard may be generally rigid, for example formed integrally with a frame or platform structure which provides a support for the blades. Guards may also comprise softer elastomeric materials to improve skin stretching. The cap and the guard aid in establishing the so-called “shaving geometry”, i.e., the parameters which determine the blade orientation and position relative to the skin during shaving, which in turn have a strong influence on the shaving performance and efficacy of the razor. The cap and the guard may aid in establishing the exposure of the blades. The blade exposure is defined to be the vertical distance or height of the blade edge measured with respect to a plane tangential to the skin contacting surfaces of the blade unit elements next in front of and next behind the edge. Therefore, for a three-bladed blade unit, the exposure of the first or primary blade is measured with reference to a plane tangential to the guard and the edge of the second blade, and the exposure of the third or tertiary blade is measured with reference to a plane tangential to the edge of the second blade and the cap.

The minimum acceptable exposure may be influenced by other blade unit dimensions, such as the distance from the skin engaging surface of the guard to the edge, i.e. “the span” of the primary blade. As referred to herein, “the span” means the distance from the blade edge to the skin contacting element immediately in front of that edge as measured along a tangent line extending between the said element and the blade edge. The guard may include a generally rigid guard bar that may be formed integrally with the housing or platform structure, which provides a support for the blades. Guards may also include skin stretching elements made from various types of elastomeric materials that are intended to stretch the skin and/or align hair in front of the blade.

Safety razors having cartridges with several blades have in recent years been sold in very large numbers and are generally acknowledged to give a better quality of shave, especially in terms of closeness, than single bladed razors. A blade unit having multiple blades can produce a closer shave than a similar blade unit with only one or two blades. However, closeness of shave obtained is only one parameter by which razor users judge the performance of a razor. Comfort is another important characteristic to consider. For example, many consumers describe themselves as having sensitive skin, which is prone to nicks, cuts and irritation. Discomfort during a shave, often described by shavers as a “pull & tug” sensation is caused by the nerves around the follicle being stimulated. This nerve stimulation can happen by moving the hairs, pulling and/or cutting the hairs and by dragging the razor cartridge over the surface of the skin.

There are a multitude of razors and razor cartridges currently on the market that have been fine tuned over the years to ensure they provide a close and comfortable shave. However, these razors and razor cartridges were designed based on consumer shaving habits more than fifteen years ago. Today, men are shaving their faces less often. Fewer men shave their faces every day, which was more of the norm fifteen years ago. In addition, more men are shaving other areas of their body, such as their chest, shoulders and underarms.

It is therefore an object of the present invention to provide a razor cartridge that is able to provide a better shave for consumers that shave more infrequently, without negatively impacting shaving performance for consumers that prefer to shave every day.

### SUMMARY OF THE INVENTION

In one aspect, the invention features, in general a shaving razor cartridge having a housing, a guard at a front of the housing and a cap at a rear of the housing. A first blade is mounted to the housing between the guard and the cap. The first blade has a cutting edge nearest the guard and a primary span measured from the cutting edge of the first blade to the guard. A second blade is mounted to the housing between the first blade and the cap. The second blade has a cutting edge and a first blade span from the cutting edge of the first blade to the cutting edge of the second blade. A third blade is mounted to the housing between the second blade and the cap. The third blade has a cutting edge and a second blade span from the cutting edge of the second blade to the cutting edge of the third blade. A fourth blade mounted to the housing between the third blade and the cap. The fourth blade has a cutting edge and a third blade span from the cutting edge of the third blade to the cutting edge of the fourth blade. A fifth blade is mounted to the housing between the fourth blade and the cap. The fifth blade has a cutting edge and a fourth blade span from the cutting edge of the fourth blade to the cutting edge of the fifth blade. A ratio of a sum of the primary span, the first blade span, the second blade span, the third blade span and the fourth blade span to the primary span is 3:1 to 6:1.

In another aspect, the invention features, in general a shaving razor cartridge having a housing, a guard at a front of the housing and a cap at a rear of the housing. A first blade is mounted to the housing between the guard and the cap. The first blade has a cutting edge nearest the guard and a primary span measured from the cutting edge of the first blade to the guard. A second blade is mounted to the housing between the first blade and the cap. The second blade has a cutting edge. A third blade mounted to the housing between the second blade and the cap. The third blade having a cutting edge. A blade plane is defined by the cutting edges of the first blade, the second blade and the third blade. A first blade angle is defined by the blade plane and a plane extending from the cutting edge of the first blade to a top surface of the guard. A second blade angle is defined by the blade plane and a plane extending from the cutting edge of the third blade to the top surface of the guard. A ratio of the first blade angle to the second blade angle is 1:1 to 4:1.

In another aspect, the invention features, in general a shaving razor cartridge having a housing, a guard at a front of the housing and a cap at a rear of the housing. A first blade including a blade support member is mounted to the housing between the guard and the cap. The first blade has a cutting edge nearest the guard and a primary span measured from the cutting edge of the first blade to the guard. A second blade including a blade support member is mounted to the housing between the first blade and the cap. The second blade has a cutting edge and a first blade span from the cutting edge of the first blade to the cutting edge of the second blade. A third blade including a blade support member is mounted to the housing between the second blade and the cap. The third blade has a cutting edge and a second blade span from the cutting edge of the second blade to the cutting edge of the third blade. A rinse gap measured between the cutting edge of the second blade and a rear face of the blade support member of the first blade is 5 times to 10 times less than the primary span.

In another aspect, the invention features, in general a shaving razor cartridge having a housing, a guard at a front of the housing and a cap at a rear of the housing. A first blade is mounted to the housing between the guard and the cap. The first blade has a cutting edge nearest the guard and a primary span measured from the cutting edge of the first blade to the guard. A second blade is mounted to the housing between the first blade and the cap. the second blade having a cutting edge. A third blade is mounted to the housing between the second blade and the cap. The third blade having a cutting edge. A blade plane is defined by the cutting edges of the first blade, the second blade and the third blade. A ratio of the primary span to a guard height is 9.5:1 to 15:1. The guard height is measured from a top surface of the guard to the blade plane.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 is a perspective view of a shaving razor cartridge.

FIG. 2A is a cross sectional schematic view of a shaving razor cartridge, taken generally along the line 2-2 of FIG. 1, during a shaving stroke.

FIG. 2B is a cross sectional schematic view of a shaving razor cartridge, taken generally along the line 2-2 of FIG. 1, during a shaving stroke.

FIG. 3 is a schematic cross-sectional view of the shaving razor cartridge of FIG. 1, generally taken along the line 2-2.

FIG. 4 is a schematic cross-sectional view of the shaving razor cartridge of FIG. 1, generally taken along the line 2-2.

FIG. 5 is a perspective view of a shaving razor cartridge.

FIG. 6 is a schematic cross-sectional view of the shaving razor cartridge of FIG. 5, generally taken along the line 6-6.

FIG. 7 is a schematic cross-sectional view of the shaving razor cartridge of FIG. 5, generally taken along the line 6-6.

FIG. 8 is a schematic cross-sectional view of the shaving razor cartridge of FIG. 5, generally taken along the line 6-6.

FIG. 9 is a graph showing the visible hair removed in a single stroke for three subjects using two different shaving razor cartridges.

### DETAILED DESCRIPTION OF THE INVENTION

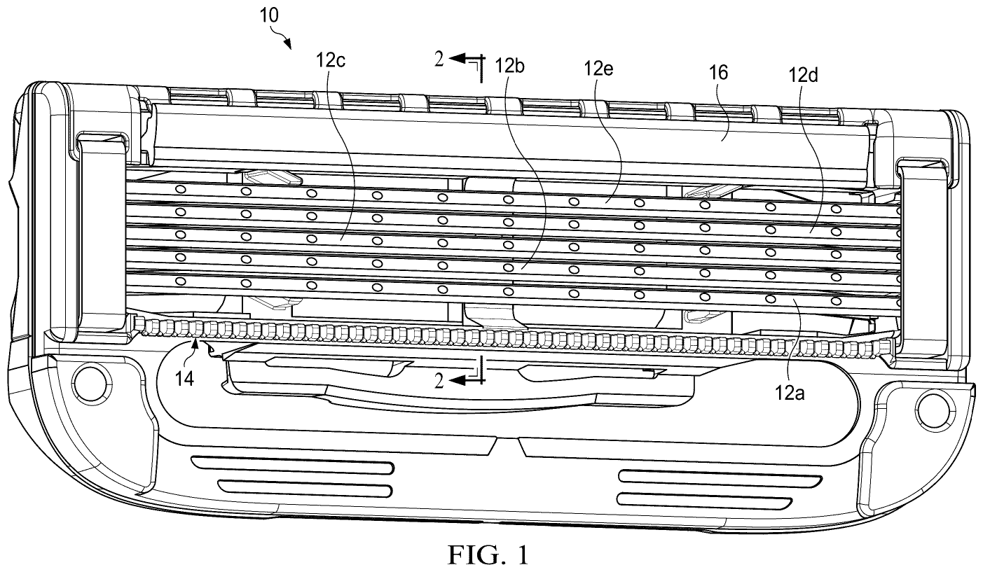

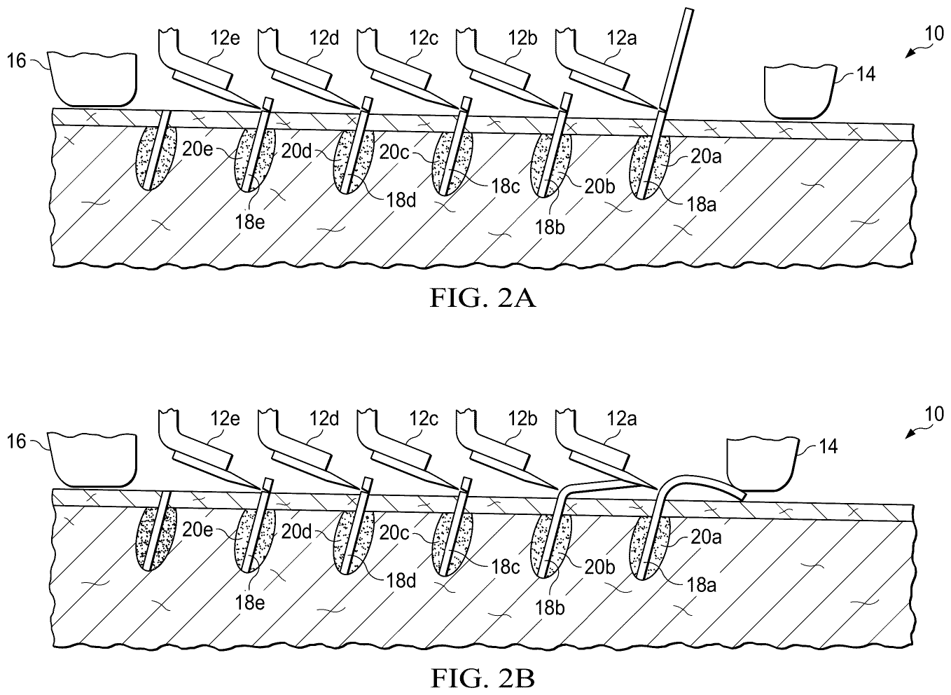

As shown in Prior Art FIG. 1, a typical shaving razor cartridge 10 comprising five blades 12a, 12b, 12c, 12d and 12e is illustrated. The five blades 12a, 12b, 12c, 12d and 12e are positioned between a guard 14 and a cap 16. FIG. 2A is a cross sectional schematic view of the shaving razor cartridge 10 taken generally along the line 2-2 of FIG. 1. FIG. 2A illustrates the shaving razor cartridge 10 during a shaving stroke for a typical consumer with one to two days hair growth. One or more hairs 18a, 18b, 18c, 18d and 18e first travel under the guard 14 prior to being engaged by the first blade 12a during a shaving stroke. The first blade 12a cuts the hair prior to the hair being engaged and cut by the subsequent blades 12b, 12c, 12d and 12e. Each of the blades 12a, 12b, 12c, 12d and 12e engages the hair and lifts the hair 18a, 18b, 18c, 18d, 18e slightly from the respective hair follicle 20a, 20b, 20c, 20d and 20e as the hairs are cut. Accordingly, each of the subsequent blades 12b, 12c, 12d and 12e can cut the hairs 18b, 18c, 18d and 18e closer than the previous blades 12a, 12b, 12c, 12d. This occurrence is known as hysteresis.

For many decades shaving razor cartridges were designed for men that shaved their faces on a regular basis (e.g., every day or every other day). However, shaving razor cartridge design has not kept up with changes in consumer habits. More and more men are skipping more than one day between shaves. FIG. 2B illustrates the interaction between the same shaving razor cartridge 10 of FIG. 1 and the hairs 18a, 18b, 18c, 18d, 18e when the hairs 18a, 18b, 18c, 18d, 18e are allowed to grow longer (e.g., 72-hour hair growth). The first hair 18a that engages the guard 14 is so long that it remains trapped under the guard 14 as the first blade 12a engages the first hair 18a. This often results in inefficient cutting of the first hair 18a, such as skive cuts or miss cuts. The longer hair being trapped may also result in double engagement of the hair (i.e., the first cutting edge 36a and the second cutting edge 36b engaging the same hair at the same time), which can result in significant discomfort caused by the tugging and pulling of the hair. The engagement of the first hair 18a by the subsequent blades 12b, 12c, 12d and 12e is also less efficient, resulting in decreased shaving performance. In addition, as the first blade 12a is responsible for cutting the longest section of hair, hair often accumulates between the first blade 12a and the guard. As hair gets clogged between the blades 12a, 12b, 12c, 12d and 12e shaving efficiency is further decreased as the blades 12a, 12b, 12c, 12d and 12e cannot properly engage the hairs 18a, 18b, 18c, 18d, 18e when cut hairs and shaving debris impede the blades 12a, 12b, 12c, 12d and 12e.

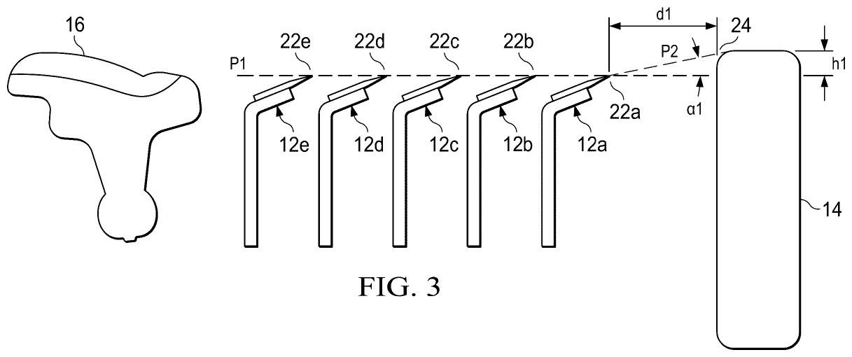

Referring to FIG. 3. a schematic cross-sectional view of the shaving razor cartridge 10 of FIG. 1, generally taken along the line 2-2. Each of the blades may have a corresponding cutting edge 22a, 22b, 22c, 22d and 22e that define a shaving plane P1. A blade angle α1 may be defined by the shaving plane P1 and a plane P2 extending from the cutting edge 22a of the first blade 12a to a top surface 24 of the guard 14. The guard 14 may have a resulting height “h1” measured from the shave plane P1 to the top surface 24 of the guard 14. A primary span “d1” may be measured as a horizontal distance from the cutting edge 22a of the first blade 12a to the guard 24 (e.g., the top surface 24 of the guard 14 contacting plane P2). Altering the primary span “d1” can have unintended negative consequences related to shave performance.

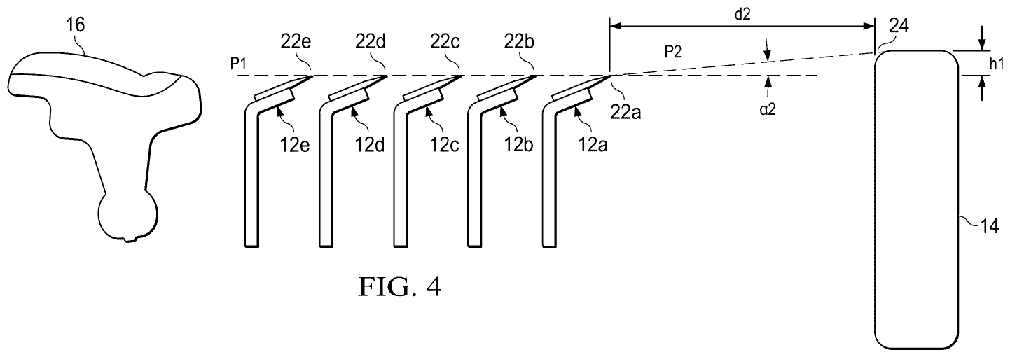

FIG. 4 illustrates a schematic cross-sectional view of the shaving razor cartridge 10 of FIG. 1, generally taken along the line 2-2, with a primary span “d2” that is greater than the primary span “d1” of FIG. 3. The cutting edge 22a, 22b, 22c, 22d and 22e may still define the shaving plane P1 shown in FIG. 3 and the height h1 of the guard 14 may still be measured from the shave plane P1 to the top surface 24 of the guard 14. However, a resulting blade angle α2 may be significantly decreased as the primary span is increased from d1 to d2. The blade angle α2 may still be defined by the shaving plane P1 and the plane P2 extending from the cutting edge 22a of the first blade 12a to the top surface 24 of the guard 14. However, the resulting blade angle α2 may be less than the blade angle α1 shown in FIG. 3 because of the increase in the primary span from d1 to d2. The increase in primary span may from d1 to d2 may result with an increase blade load on the skin. The decrease in the angle α1 to the angle α2 may also result non optimal cutting angle (i.e., an angle the cutting edge engages the hair and skin). These factors may negatively decrease shaving performance (e.g., closeness and comfort).

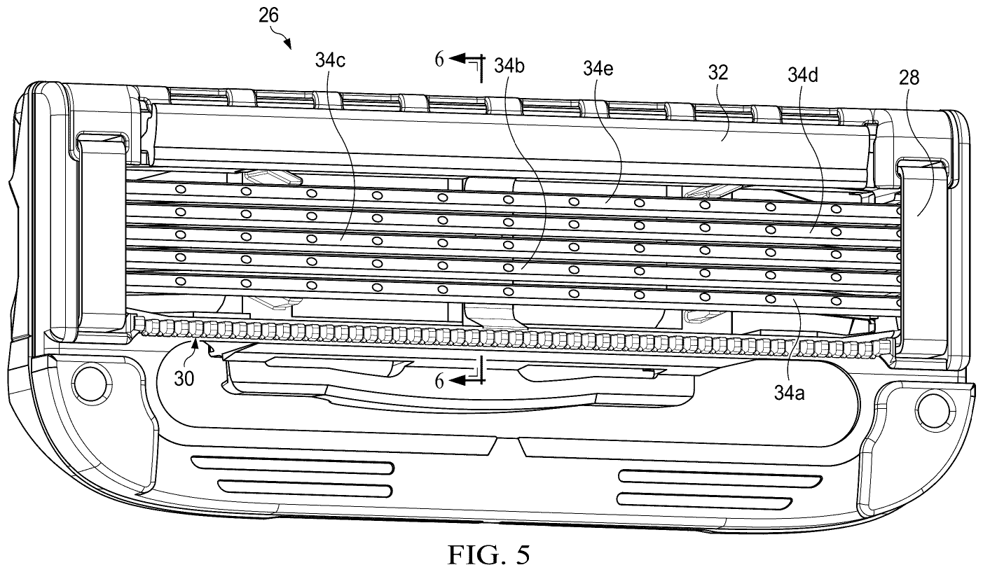

Referring to FIG. 5, a perspective view is shown of a shaving razor cartridge 26 having a more optimized shaving geometry. The shaving razor cartridge 26 may be mounted detachably on a handle (not shown) to enable the shaving razor cartridge 26 to be replaced by a fresh shaving razor cartridge 26 when shaving performance has diminished to an unsatisfactory level, or the shaving razor cartridge 26 may be attached permanently to a handle (not shown) with the intention that the entire razor be discarded when shaving performance becomes unsatisfactory to the user (i.e., disposable razor). The connection of the shaving razor cartridge 26 to a handle (not shown) may provide pivotal mounting of the shaving razor cartridge 26 with respect to the handle so that the shaving razor cartridge 26 angle adjusts to follow the contours of the surface being shaved.

The shaving razor cartridge 26 may include a housing 28 having a guard 30 toward a front of the housing 28 and a cap 32 toward a rear of the housing 28. In certain embodiments, a plurality of blades 34a, 34b, 34c, 34d and 34e may be mounted to the housing 28 between the guard 30 and the cap 32. Although five blades 34a, 34b, 34c, 34d and 34e are illustrated, it is understood that more or fewer blades may be mounted to the housing 28, depending on the desired cost and performance of the shaving razor cartridge 28. In certain embodiments, the cap 32 may comprise a lubricous material, which may reduce irritation, especially on re-strokes where most of the shave prep has been removed by the blades 34a, 34b, 34c, 34d and 34e.

In certain embodiments, the cap 32 may include a water leachable shaving aid such as a polymeric matrix comprising a water soluble polymer and a water-insoluble polymer comprising ethylene vinyl acetate (EVA). Other typical lubricious water soluble polymers may include polyethylene oxide, polyvinyl pyrrolidone, polyacrylamide, modified hydroxyalkyl cellulose, polyvinyl imidazoline, polyvinyl alcohol, polysulfone, and polyhydroxyethylmethacrylate. The preferred lubricious water-soluble polymer is polyethylene oxide. The more preferred polyethylene oxides generally are known as POLYOX (available from Union Carbide Corporation) or ALKOX (available from Meisei Chemical Works, Kyoto, Japan). These polyethylene oxides will preferably have molecular weights of about 100,000 to 8 million Daltons, most preferably about 300,000 to 5 million Daltons. It is preferred to use a blend of polyethylene oxides, typically a blend having at least one polyethylene oxide having a molecular weight in the range of 100,000 to 500,000 and at least one polyethylene oxide having a molecular weight in the range of 3 million to 8 million. The most preferred polyethylene oxide comprises a blend of about 40% to 80% by weight of polyethylene oxide having an average molecular weight of about 5 million (e.g., POLYOX COAGULANT) and about 60% to 20% of polyethylene oxide having an average molecular weight of about 300,000 (e.g., POLYOX WSR-N-750). A 60:40 blend of these two polyethylene oxides million: 300,000) is especially preferred.

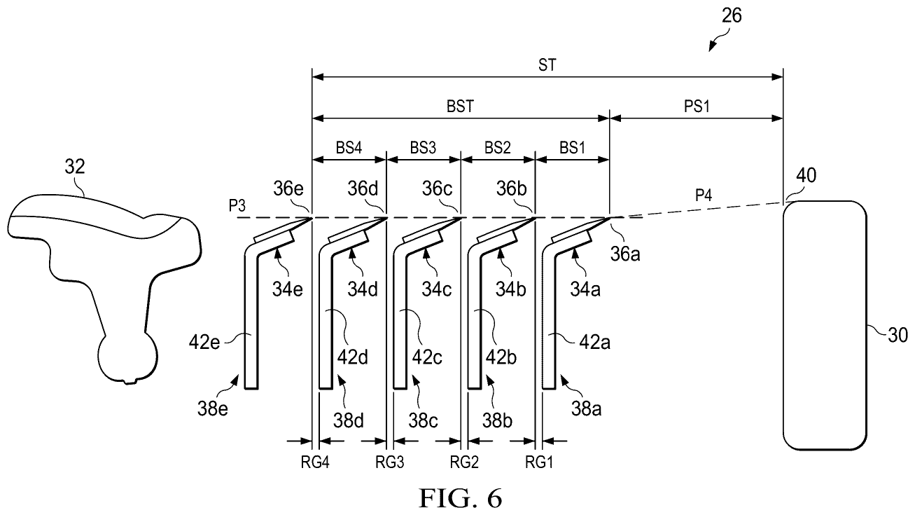

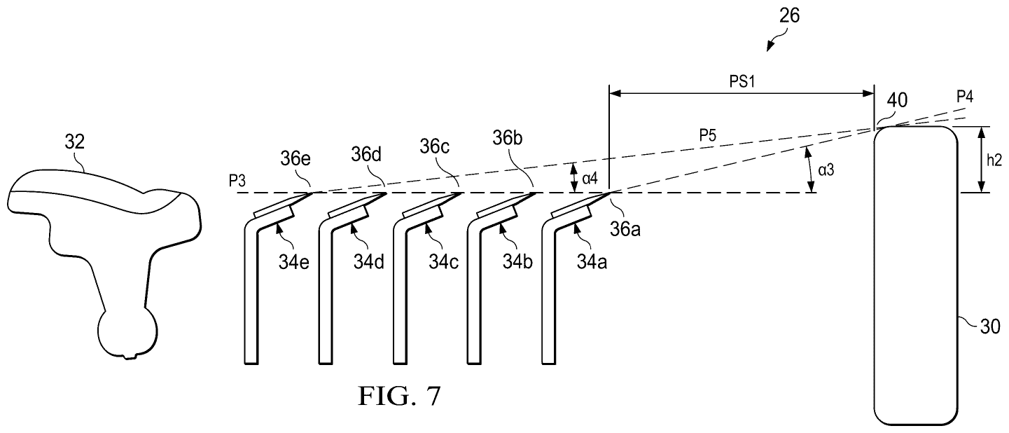

FIGS. 6 and 7 illustrate a schematic cross-sectional view of the shaving razor cartridge 26 of FIG. 5, generally taken along the line 6-6, of FIG. 5. As shown FIG. 6, each of the blades 34a, 34b, 34c, 34d and 34e may have a respective cutting edge 36a, 36b, 36c, 36d and 36e facing toward the guard 30. The cutting edge 36a, 36b, 36c, 36d and 36e may define a blade plane P3. In certain embodiments, each of the blades 34a, 34b, 34c, 34d and 34e may include a blade support member 38a, 38b, 38c, 38d and 38e. However, it is understood the blades 34a, 34b, 34c, 34d and 34e may alternately have a cutting-edge integral with the blade support member (e.g., a bent blade). A first rinse gap RG1 may extend between the cutting edge 36b of the second blade 34b and a rear face 42a of the blade support member 38a of the first blade 34a. A second rinse gap RG2 may extend between the cutting edge 36c of the third blade 34c and a rear face 42b of the blade support member 38b of the second blade 34b. A third rinse gap RG3 may extend between the cutting edge 36d of the fourth blade 34d and a rear face 42c of the blade support member 38c of the third blade 34c. A fourth rinse gap RG4 may extend between the cutting edge 36e of the fifth blade 34e and a rear face 42d of the blade support member 38d of the third blade 34d.

The shaving razor cartridge 26 may have a plane “P4” that extends from the cutting edge 36a of the first blade 34a to a top surface 40 of the guard 30. A primary span “PS1” may extend from the cutting-edge 36a or the first blade 34a to the top surface 40 of the guard 30 (e.g., at P4). A first blade span “BS1” may extend from the cutting edge 36a of the first blade 34a to the cutting-edge 36b of the second blade 34b. A second blade span “BS2” may extend from the cutting edge 36b of the second blade 34b to the cutting-edge 36c of the third blade 34c. A third blade span “BS3” may extend from the cutting edge 36c of the third blade 34c to the cutting-edge 36d of the fourth blade 34c. A fourth blade span “BS4” may extend from the cutting edge 36d of the fourth blade 34d to the cutting-edge 36e of the fifth blade 34e. In certain embodiments, one or more of the blade spans BS1, BS2, BS3 and BS4 may be 5% to 20%, preferably 8% to 16% less than the primary blade span “PS1”. An average of the blade spans BS1, BS2, BS3 and BS4 may be 5% to 20% and more preferably 10% to 15% less than the primary blade span “PS1” to facilitate the cutting of longer hairs closer and more efficiently. Similarly, an average of the blade spans BS1 and BS2 may be 5% to 20% and more preferably 10% to 15% less than the primary blade span “PS1” to facilitate the cutting of longer hairs closer and more efficiently.

A total blade span “BST” may be measured from the cutting edge 36e of the blade 34e closest to the cap 32 (e.g., the fifth blade 34e) to the cutting edge 36a of the blade 34a of closest to the guard 30. A total span “ST” may be measured from the top surface 40 of guard 30 (e.g., at P4) to the cutting edge 36e of the blade 34e closest to the cap 32. The primary span “PS1” may be 22% to 24% of the total span “ST”. The primary span “PS1” may be 25% to 30% of the total blade span “BST”.

The first rinse gap RG1, the second rinse gap RG2, third rinse gap RG3, and/or the fourth rinse gap RG4 may be less than the primary span “PS1”. Since the second blade 34b, the third blade 34c, the fourth blade 34d and the fifth blade 34e are cutting a shorter length of hair compared to the first blade 34a, the rinse gaps RG1, RG2, RG3 and/or RG4 may be smaller, thus allowing for the cutting edges 36b, 36c, 36d and 36e to be spaced closer. The spacing of the second blade 34b, the third blade 34c, the fourth blade 34d and the fifth blade 34e may allow for increased closeness and comfort, without sacrificing rinsing because longer hair length is cut by the cutting edge 36a of the first blade 34a and falls into the gap between the cutting-edge 36a of the first blade 34a and the guard 30 (i.e., within the primary span “PS1”). In certain embodiments, the first rinse gap RG1 may be less than the primary span “PS1”. For example, the first rinse gap RG1 may be at least 4 times less than the primary span “PS1”, such as 5 to 25 times less than the primary span “PS1”, preferably 5 to 10 times less than the primary span “PS1”. Similarly, the second rinse gap RG2, the third rinse gap RG3 and/or the fourth rinse gap RG4 may be at least 4 times less than the primary span “PS1”, such as 5 to 25 times less than the primary span “PS1”, preferably 5 to 10 times less than the primary span “PS1”. The rinse gaps RG1, RG2, RG3, and RG4 may be smaller without clogging due to the increased primary blade span “BS1” cutting longer hairs more efficiently. Accordingly, smaller rinse gaps may be achieved to facilitate in the design of smaller cartridges. For example, the rinse gaps RG1, RG2, RG3, and/or RG4 may be 0.05 mm to t 0.20 mm and more preferably 0.05 mm to 0.15 mm. The rinse gaps RG1, RG2, RG3, and/or RG4 may also be calculated as a percentage of the primary span “PS1”. For example, the rinse gaps RG1, RG2, RG3, and/or RG4 may be 9% to 20% of the primary span “PS1”. In certain embodiments, a ratio of the rinse gaps RG1, RG2, RG3, or RG4 to the primary span “PS1” may be 1:20 to 1:5, and more preferably 9:100 to 1:10.

In certain embodiments, a ratio of a sum of the blade spans BS1, BS2, BS3 and BS4 (i.e., a total blade span “BST” from the cutting edge 36e of the blade 34a closest to the cap 32 to the cutting edge 36a of the blade 34a closest to the guard 30) and the primary span to the primary span may be 3:1 to 6:1. For example, a ratio of a sum of the primary span “PS1”, the first blade span “BS1, the second blade span “BS2”, the third blade span “BS3” and the fourth blade span “BS4” to the primary span “PS1” may be 3.5:1 to 6:1, preferably 3.9:1 to 4.7:1 and more preferably 4.4:1 to 4.6:1. It is understood that shaving razor cartridges having more or fewer blades may also have a ratio between the various blade spans and the primary span “PS1”. For example, for a three bladed system, a ratio of a sum of the primary span “PS1”, the first blade span “BS1 and the second blade span “BS2” to the primary span “PS1” may be 2:1 to 4.2:1, preferably 2.4:1 to 2.9:1 and more preferably 2.5:1 to 2.8:1. For example, for a four bladed system, a ratio of a sum of the primary span “PS1”, the first blade span “BS1, the second blade span “BS2” and the third blade span “BS3” to the primary span “PS1” may be 2:1 to 5.6:1, preferably 3:1 to 4:1 and more preferably 3.2:1 to 3.8:1.

The primary span “PS1” may be equal to or greater than 1.0 mm. For example, primary span “PS1” may be 1.0 mm to 2.0 mm and preferably 1.0 mm to 1.5 mm and more preferably 1.1 mm to 1.25 mm. In certain embodiments, the first blade span “BS1, the second blade span “BS2”, the third blade span “BS3” and the fourth blade span “BS4” may each be less than the primary span “PS1”. For example, the blade spans BS1, BS2, BS3 and BS4 may each be 0.25 mm to 1.1 mm and preferably 0.75 mm to 0.95 mm. In certain embodiments, an average of the first blade span “BS1”, the second blade span “BS2”, the third blade span “BS3” and the fourth blade span “BS4” is 0.85 mm to 1.05 mm. In certain embodiments, the first blade span “BS1” and the second blade span “BS2” may be larger than the third blade span “BS3” and the fourth blade span “BS4”. For example, an average of the first blade span “BS1” and the second blade span “BS2” may be 0.9 mm to 1.1 mm. A total span “ST” from the cutting edge 36e of the fifth blade 34e to the top surface 40 of the guard 30 may be 4 mm to 6 mm and preferably 4.75 mm to 5.5 mm and more preferably 4.8 mm to 5.1 mm. The total span “ST” may be measured as the distance parallel to the blade plane P3 from the cutting edge 36e of the fifth blade 34e to the (projected) top surface 40 of the guard 30. The primary span “PS1” may account for a larger percentage of the total span “ST”. For example, the primary span “PS1” may be about 22% to 24% of the total span “ST”. In certain embodiments, a ratio of an average of the blade spans BS1, BS2, BS3 and BS4 to the primary blade span “PS1” may be 2:1 to 5:1, preferably 3:1 to 4:1 and more preferably 3.25:1 to 3.75:1.

As shown in FIG. 7, a blade angle α3 (i.e., blade angle of the first blade 34a) may be defined by the shaving plane P3 and a plane P4 extending from the cutting edge 36a of the first blade 34a to the top surface 40 of the guard 30. The guard 30 may have a resulting height “h2” measured from the shave plane P3 to the top surface 40 of the guard 30 (e.g., at P4) of 0 mm to 0.25 mm and more preferably 0.05 mm to 0.15 mm. In certain embodiments, the blade angle α3 may be 3 degrees to 13 degrees, preferably 4 degrees to 6 degrees and more preferably 5.4 to 5.8 degrees. A blade angle α4 of the blade 34e closest to the cap 32 may be defined by the shaving plane P3 and a plane P5 extending from the cutting edge 36e of the blade 34e closest to the cap 32 (e.g., the fifth blade 34e) to the top surface 40 of the guard 30. In certain embodiments, the blade angle α4 may be 0.75 degrees to 2.9 degrees, preferably 0.8 degrees to 2.4 degrees and more preferably 1.0 degrees to 1.5 degrees. A ratio of the blade angle α3 (i.e., blade angle of the first blade 34a) to the blade angle α4 (i.e., blade angle of the blade 34e closest to the cap 32) may be 1.2:1 to 14.7:1, preferably 2:1 to 7:1 and more preferably 4:1 to 5:1. In certain embodiments, a ratio of the primary span “PS1” to the guard height “h2” may be 9:1 to 20:1, preferably 9.5:1 to 15:1, and more preferably 9.5:1 to 11:1.

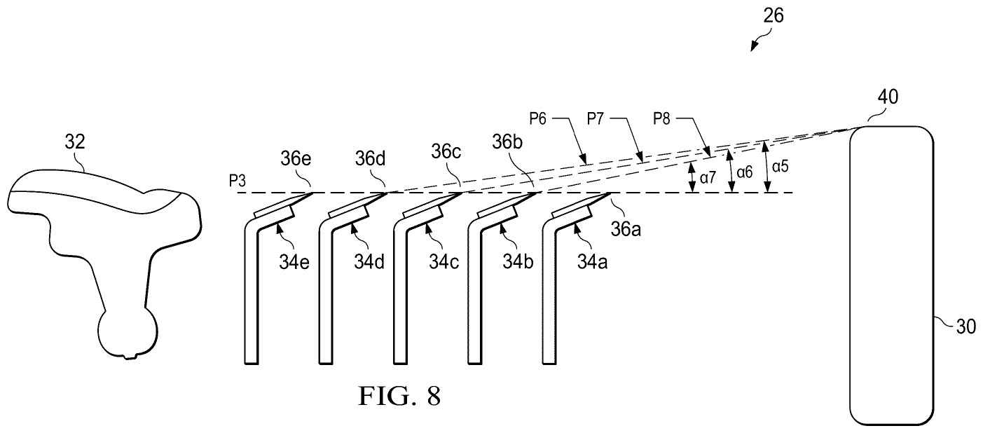

Referring to FIG. 8, the second blade 34b, the third blade 34c and the fourth blade 34d may also have blade angles. For example, a blade angle α5 (i.e., blade angle of the fourth blade 34d) may be defined by the shaving plane P3 and a plane P6 extending from the cutting edge 36d of the fourth blade 34d to the top surface 40 of the guard 30. A blade angle α6 (i.e., blade angle of the third blade 34c) may be defined by the shaving plane P3 and a plane P7 extending from the cutting edge 36c of the third blade 34c to the top surface 40 of the guard 30. A blade angle α7 (i.e., blade angle of the second blade 34b) may be defined by the shaving plane P3 and a plane P8 extending from the cutting edge 36b of the second blade 34b to the top surface 40 of the guard 30.

It is understood that shaving razor cartridges having more, or fewer blades may have a similar blade angle ratios as previously described for the blade angle α4 of the blade 34e closest to the cap 32. For example, for a three bladed shaving razor cartridge, a ratio of the blade angle α3 (i.e., blade angle of the first blade 34a) to the blade angle α6 (i.e., blade angle of the third blade 34c) may be 4:5 to 4:1, preferably 2:1 to 4:1 and more preferably 2:1 to 3:1. A four bladed shaving razor cartridge may have a ratio of the blade angle α3 (i.e., blade angle of the first blade 34a) to the blade angle α5 (i.e., blade angle of the fourth blade 34c) may be 1 to 12, preferably 2 to 5 and more preferably 3:1 to 4:1. A two bladed shaving razor cartridge may have a ratio of the blade angle α3 (i.e., blade angle of the first blade 34a) to the blade angle α7 (i.e., blade angle of the second blade 34b) may be 1:2 to 6:1, preferably 1:1 to 4:1 and more preferably 1.5:1 to 2.5:1. In certain embodiments, a ratio of the blade angle α3 (i.e., blade angle of the first blade 34a) to an average of the blade angles α4, α5, α6 and α7 may be 1.5 to 5.6, preferably 2:1 to 4:1.

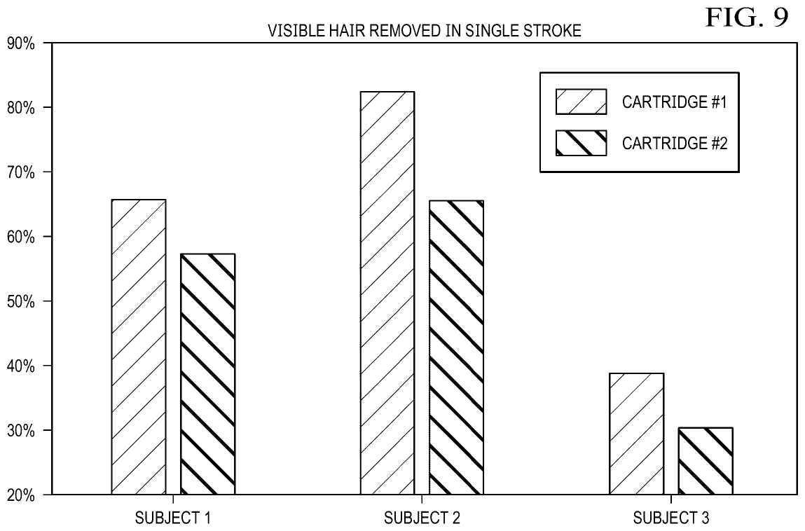

Referring to FIG. 9, a graph is shown illustrating the visible hair removed in a single stroke for three subjects using two different shaving razor cartridges. Both shaving razor cartridges had five blades and the same handle. Both shaving razor cartridges had five blades and the same housing. Cartridge #2 had the blades spaced apart according to currently available product on the market). Cartridge #1 had the blades spaced apart according to the present invention. Table 1 shown below, provides the cartridge specifications for Cartridge #1 and Cartridge #2. It is understood that the values provided for the Cartridge #1 and Cartridge #2 also include typical manufacturing and measuring tolerances and are not intended to be exact representations. Subjects made a single down stroke on an unshaved section of their face with both cartridges using the same shaving preparations. An enlarged before and after image of the area shaved was taken and the number of hairs were counted before and after each shave stroke. Any visible hairs were counted as an uncut hair (e.g., partially cut hairs). Cut hairs were calculated as the original pre-shave hairs less the visible hair in the post-shave image. Cartridge #1 removed more visible hair in a single stroke in all three subjects compared to Cartridge #2.

TABLE 1
Cartridge Specifications

| | Cartridge #2 | Cartridge #1 |
|---|---|---|
| Guard | 0.11 | 0.11 |
| Height (mm) | | |
| PS1 (mm) | 0.64 | 1.1 |
| BS1 (mm) | 1.05 | 1 |
| BS2 (mm) | 1.05 | 0.95 |
| BS3 (mm) | 1.05 | 0.95 |
| BS4 (mm) | 1.05 | 0.95 |
| α3 (degrees) | 9.67 | 5.71 |
| α7 (degrees) | 3.71 | 3 |
| α6 (degrees) | 2.29 | 2.07 |
| α5 (degrees) | 1.66 | 1.58 |
| α4 (degrees) | 1.3 | 1.27 |

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor cartridge, comprising:
a housing;
a guard at a front of the housing;
a cap at a rear of the housing;
a first blade mounted to the housing between the guard and the cap, the first blade having a cutting edge nearest the guard and a primary span measured from the cutting edge of the first blade to the guard;
a second blade mounted to the housing between the first blade and the cap, the second blade having a cutting edge; and
a third blade mounted to the housing between the second blade and the cap, the third blade having a cutting edge;
a blade plane defined by the cutting edges of the first blade, the second blade and the third blade;
a first blade angle defined by the blade plane and a plane extending from the cutting edge of the first blade to a top surface of the guard;
a second blade angle defined by the blade plane and a plane extending from the cutting edge of the third blade to the top surface of the guard, wherein a ratio of the first blade angle to the second blade angle is 4:5 to 4:1.

2. The shaving razor cartridge of claim 1 wherein a ratio of the first blade angle to the second blade angle is 2:1 to 4:1.

3. The shaving razor cartridge of claim 1 wherein the first blade angle is 3 degrees to 13 degrees.

4. The shaving razor cartridge of claim 1 wherein the second blade angle is 1 degrees to 5 degrees.

5. The shaving razor cartridge of claim 1 wherein the first blade angle is 3 degrees to 10 degrees and the second blade angle is 1 degrees to 5 degrees.

6. The shaving razor cartridge of claim 1 wherein the primary span is greater than 1.0 mm.

7. The shaving razor cartridge of claim 1 wherein the primary span is less than or equal to 1.25 mm.

8. The shaving razor cartridge of claim 1 wherein the primary span is greater than 1.0 mm and less than or equal to 1.25 mm.

9. The shaving razor cartridge of claim 1 wherein the ratio of the first blade angle to the second blade angle is 1:1 to 4:1.

10. The shaving razor cartridge of claim 1 wherein a first blade span measured from the cutting edge of the second blade to the cutting edge of the first blade is less than the primary span.

11. The shaving razor cartridge of claim 10 wherein a second blade span measured from the cutting edge of the second blade to the cutting edge of the third blade is less than the primary span.

12. The shaving razor cartridge of claim 10 wherein the first blade span is 5% to 20% less than the primary span.

13. The shaving razor cartridge of claim 10 wherein the first blade span 8% to 16% less than the primary span.

14. A shaving razor cartridge, comprising:
a housing;
a guard at a front of the housing;
a cap at a rear of the housing;
a first blade mounted to the housing between the guard and the cap, the first blade having a cutting edge nearest the guard and a primary span measured from the cutting edge of the first blade to the guard;
a second blade mounted to the housing between the first blade and the cap, the second blade having a cutting edge; and
a third blade mounted to the housing between the second blade and the cap, the third blade having a cutting edge;
a fourth blade mounted to the housing between the third blade and the cap, the fourth blade having a cutting edge;
a fifth blade mounted to the housing between the fourth blade and the cap, the fifth blade having a cutting edge;
a blade plane defined by the cutting edges of the first blade, the second blade, the third blade, the fourth blade and the fifth blade;
a first blade angle defined by the blade plane and a plane extending from the cutting edge of the first blade to a top surface of the guard;
a second blade angle defined by the blade plane and a plane extending from the cutting edge of the fifth blade to the top surface of the guard, wherein a ratio of the first blade angle to the second blade angle is 2:1 to 7:1.

15. The shaving razor cartridge of claim 14 wherein a ratio of the first blade angle to the second blade angle is 4:1 to 5:1.

16. The shaving razor cartridge of claim 14 wherein the first blade angle is 3 degrees to 13 degrees.

17. The shaving razor cartridge of claim 14 wherein the second blade angle is 0.5 degrees to 5 degrees.

18. The shaving razor cartridge of claim 14 wherein the first blade angle is 3 degrees to 10 degrees and the second blade angle is 0.5 degrees to 5 degrees.

19. The shaving razor cartridge of claim 14 wherein the primary span is greater than 1.0 mm.

20. The shaving razor cartridge of claim 14 wherein the primary span is less than or equal to 1.25 mm.
